(19) United States
(12) Patent Application Publication
(10) Pub. No.: US 2014/0068350 A1
(43) Pub. Date: Mar. 6, 2014

(54) SELF-CHECKING SYSTEM AND METHOD USING SAME

(71) Applicants: Hon Hai Precision Industry Co., Ltd., New Taipei (TW); Hong Fu Jin Precision Industry (ShenZhen) Co., Ltd., Shenzhen (CN)

(72) Inventor: WEN-JIE ZHANG, Shenzhen (CN)

(73) Assignees: Hon Hai Precision Industry Co., Ltd., New Taipei (TW); Hong Fu Jin Precision Industry (ShenZhen) Co., Ltd., Shenzhen (CN)

(21) Appl. No.: 14/013,063

(22) Filed: Aug. 29, 2013

(30) Foreign Application Priority Data
Aug. 29, 2012 (CN) 201210311842X

(51) Int. Cl. G06F 11/34

(52) U.S. Cl. CPC G06F 11/34
USPC 714/47.2

(57) ABSTRACT

An electronic apparatus controlled by a self-checking system. The self-checking system constantly detects and stores, in a limited storage, a number of state characteristics of the electronic apparatus and constantly writes over and thus deletes previous data. An operating system in the electronic apparatus transmits a reset instruction before the expiry of predetermined time intervals. The self-checking system starts a timing process when the operating system is started and resets the timing process when a reset instruction is received from the operating system. If a reset instruction is not received before the expiry of a predetermined time interval, the self-checking system stores the instantaneous state characteristic of the electronic apparatus to make preparation for a failure analysis by the user.

### TECHNICAL FIELD

The disclosure generally relates to self-checking technologies, and particularly to a self-checking system and method for an electronic device.

### DESCRIPTION OF RELATED ART

Generally, when a machine, such as a computer or a server, crashes, an instantaneous working state of the computer of the server at the time of the crash cannot be timely recorded. Thus, an administrator cannot get enough reference information to fix the machine.

Therefore, it is desirable to provide a means which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic apparatus including a self-checking system.

FIG. 2 is a flowchart of an exemplary embodiment of a self-checking method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

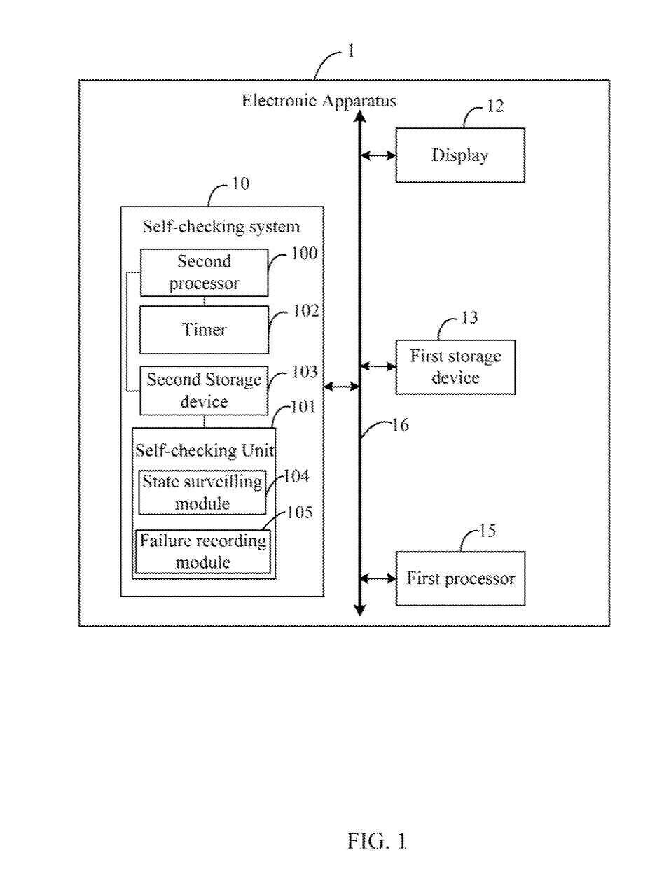

FIG. 1 is a block diagram of one embodiment of an electronic apparatus 1 including a self-checking system 10. The self-checking system 10 detects a working state of the electronic apparatus 1 and automatically stores a number of state characteristics of the electronic apparatus 1, such as working voltages of each element of electronic apparatus 1, when the electronic apparatus 1 crashes. The electronic apparatus crashing means that a situation in which the electronic apparatus fails to work normally, such as a running program is jammed or an electrical accident to shut down the electronic apparatus. The electronic apparatus 1 includes a display 12, a first storage device 13, and a first processor 15. The first storage device 13 stores an operating system of the electronic apparatus 1. The operating system is executed by the first processor 15 and is displayed in a form of a user interface by the display 12. The self-checking system 10 is independent from the first processor 15 and the operating system. The display 12, the first storage device 13, the first processor 15, and the self-checking system 10 are directly or indirectly electrical connected via a bus 16 for exchange of data or control signals. In this embodiment, the electronic apparatus 1 is selected from a group consisting of a computer, a server, and an intelligent mobile terminal.

The self-checking system 10 includes a second processor 100, a self-checking unit 101, a timer 102, and a second storage device 103. The self-checking unit 101 includes a state surveilling module 104 and a failure recording module 105. The self-checking unit 101 is stored in the second storage device 103 and executed by the second processor 100, or may be a firmware embedded in the second processor 100. The second processor 100, the timer 102, and the second storage device 103 are directly or indirectly electrical connected for the exchange of data or control signals. In this embodiment, the self-checking system 10 is a baseboard management controller (BMC) of a baseboard of the electronic apparatus 1. The second processor 100 may be an advanced reduced instruction set computer machine central processing unit (ARM CPU).

The timer 102 starts a timing process and resets the timing process according to a reset instruction transmitted from the operating system. The timer 102 starts the timing process when the operating system starts to work. The operating system transmits a reset instruction to reset the timer 102 to zero within a predetermined time interval as long as the electronic device works normally. Thus, if the timer 102 does not receive a reset instruction within the time interval, this means the electronic apparatus crashes, and the timer 102 generates a checking instruction. The checking instruction is configured to control the failure recording module 105 to stores the state characteristics of the electronic apparatus. In this embodiment, the timer 102 is a watch dog timer (WDT).

The state surveilling module 104 instantaneously detects the state characteristics of the electronic apparatus 1, for example, the state surveying module 104 acquires working voltages and temperatures of different elements from the basic input output system (BIOS), acquires different progresses of a number of running programs, and captures a display interface of the operating system from a graphic card. The state characteristics are temporarily stored in a storage space of the second storage device 103 defined by the state surveilling module 104.

The failure recording module 105 stores the state characteristics temporarily stored in the first storage device 13 or the second storage device 103 when the checking instruction is received. Because the storage space is limited and only stores the state characteristics for a short time, the subsequent state characteristics writes over and effectively deletes a preceding state characteristics stored in the storage space. Therefore, when the electronic apparatus crashes, the state characteristics needs to be stored in the first storage device 13 or the second storage device 103 to make preparation for a failure analysis.

The second storage device 103 stores an interface program. The interface program is executed by the second processor 100 to provide a user interface to display the state characteristics stored in the first storage device 13. In this embodiment, the interface program is a Web graphic user interface (WebGUI). The WebGUI provides a webpage via the display 12. The webpage includes a play button. A user may manipulate the webpage and clicks the play button to review the state characteristics stored when the operating system crashed. In this embodiment, the second storage device 103 is flash memory. The WebGUI is a firmware written in the flash memory.

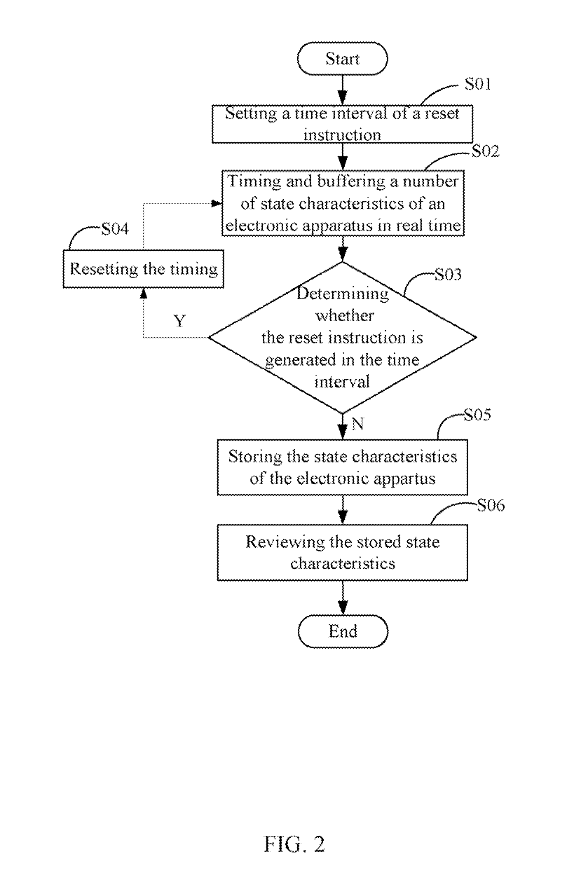

FIG. 2 is a flowchart of an exemplary embodiment of a self-checking method. Depending on the embodiment, additional steps may be added, others deleted, and the ordering of the steps may be changed.

In step S01, setting a time interval for resetting the timer 102, the operating system transmits a reset instruction to reset the timer 102 within a predetermined time interval.

In step S02, timing and instantaneously detecting the state characteristics, to start a timing process of the timer 102 when the operating system starts to work. The state surveilling module 104 instantaneously detects the state characteristics of the electronic apparatus 1.

In step S03, determining whether the timer 102 receives the reset instruction.

In step S04, when the timer 102 receives the reset instruction from the operating system, the timer 102 resets the timing process.

In step S05, storing the state characteristics, if the timer 102 does not receive the reset instruction from the operating system within the time interval, the timer 102 generates a checking instruction to control the failure recording module 105 to store the state characteristics of the electronic apparatus 1 currently being detected by the state surveilling module 104.

In step S06, reviewing the state characteristics, the user executes an interface program to review the state characteristics stored when the electronic apparatus crashes.

The self-checking system 10 and method automatically detects the state characteristics of the electronic apparatus 1 and stores the state characteristics when the electronic apparatus 1 crashes. Therefore, the user can review and analyze the state characteristics of the electronic apparatus 1, which improves accuracy and efficiency of repairing the electronic apparatus 1.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An electronic apparatus controlled by an operating system, the operating system transmitting a reset instruction within a predetermined time interval, the electronic apparatus comprising:
a timer that starts a timing process and resets the timing process when the reset instruction from the operating system is received;
a storage device;
a processor; and
a self-checking unit stored in the storage device and executed by the processor, the self-checking system comprising:
a state surveilling module that checks a plurality of state characteristics of the electronic apparatus; and
a failure recording module that stores the state characteristic detected by the state surveilling module in the storage device when the timer does not receive the reset instruction from the operating system within the predetermined time interval.

2. The self-checking system of claim 1, wherein the self-checking system is a baseboard management controller of a baseboard of the electronic apparatus.

3. The self-checking system of claim 1, wherein the state characteristic of the electronic apparatus comprises working voltages of different elements of the electronic apparatus, working temperatures of different elements of the electronic apparatus, different progresses of a plurality of running programs, and a display interface of the operating system.

4. The self-checking system of claim 1, wherein the timer is a watch dog timer.

5. The self-checking system of claim 1, wherein the storage device stores an interface program, the interface program is executed by the processor to provide a user interface to display the state characteristics stored in the storage device.

6. The self-checking system of claim 5, wherein the interface program is a Web graphic user interface.

7. The self-checking system of claim 5, wherein the interface program is a firmware written in the storage device.

8. The self-checking system of claim 1, wherein the processor is an advanced reduced instruction set computer machine central processing unit.

9. The self-checking system of claim 1, wherein the self-checking unit is a firmware embedded in the processor.

10. A self-testing method for checking a plurality of state characteristics of an electronic apparatus controlled by an operating system, the operating system transmitting a reset instruction within a predetermined time interval, the method comprising:
setting the time interval of the reset instruction;
starting a timing process and buffering the state characteristics of the electronic apparatus when the electronic apparatus starts to work;
determining whether the reset instruction is generated within the time interval, resetting the timing process when the reset instruction is generated within the time interval,; and
storing the state characteristics of the electronic apparatus when there is no reset instruction is generated within the time interval.

11. The method of claim 10, further comprising:
executing an interface program to review the stored state characteristics of the electronic apparatus.

12. The method of claim 11, wherein the interface program is a Web graphic user interface.

13. The method of claim 10, wherein the state characteristic of the electronic apparatus comprises working voltages of different elements of the electronic apparatus, working temperatures of different elements of the electronic apparatus, different progresses of a plurality of running programs, and a display interface of the operating system.
